(19) United States
(12) Patent Application Publication
(10) Pub. No.: US 2022/0292539 A1
(43) Pub. Date: Sep. 15, 2022

(54) SIZZLE THE OFFER ENGINE

(71) Applicant: Brian H. Weiner, Calabasas, CA (US)

(72) Inventor: Brian H. Weiner, Calabasas, CA (US)

(73) Assignee: Sizzle, Inc., Calabasas, CA (US)

(21) Appl. No.: 17/691,078

(22) Filed: Mar. 9, 2022

Related U.S. Application Data
(60) Provisional application No. 63/200,491, filed on Mar. 10, 2021.

(51) Int. Cl. G06Q 30/02

(52) U.S. Cl. CPC G06Q 30/0211; G06Q 30/0246; G06Q 30/0239

(57) ABSTRACT

A business and a technology platform uses triggers for making all forms of media, technologies and locations, instantly transactional, informational and interactive, on mobile devices, iot devices, virtual devices, tablets, and robots using a pull advertising/marketing model having triggers. The triggers include visual recognition, character recognition, machine learning, neural network, artificial intelligence, GPS, beacon, rfid, qr code, search, time, voice recognition, face recognition, expression recognition, object recognition, audio signals, augmented reality, screen pressure sensitivity, and games of all kinds, in all formats. Instantaneous transactional capabilities are also added. The platform also uses combinations of presentations in all media.

### CROSS REFERENCE TO RELATED APPLICATIONS

This application claims the priority of Provisional Application No. 63/200,491 filed on Mar. 10, 2021, having inventor Brian H. Weiner, entitled “Sizzle The Offer Engine”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to a business and a technology platform which uses triggers for making all forms of media, technologies and locations, instantly transactional, informational and interactive, on mobile devices, iot devices, virtual devices, tablets, and robots using a pull advertising/marketing model; and wherein the triggers include visual recognition, character recognition, machine learning, neural network, artificial intelligence, GPS, beacon, rfid, qr code, search, time, voice recognition, face recognition, expression recognition, object recognition, audio signals, augmented reality, screen pressure sensitivity, and games of all kinds, in all formats.

### BACKGROUND OF THE INVENTION

The Sizzle Network generally facilitates a transaction, or an exchange of information and interactivity with the end user. The Sizzle Network achieves this through the use of a cloud based system in which the Sizzle Offer Engine is hosted. The Sizzle Offer Engine is accessible through any web portal, for programming and distribution of offers in a narrow or broad manner, including:

| | |
|---|---|
| A pressure sensitive top layer | Artificial intelligence stimuli |
| Gesture recognition | QR Code recognition |
| A selective frequency audio listening | Search |
| system | Time-based |
| Scanning a visual trigger | Facial recognition |
| Receiving a GPS signal | Insertion into games |
| Machine learning-based stimuli | Insertion into augmented reality |
| Reacting to beacon signals | Insertion into mixed or virtual reality |
| Reacting to RFID signals | |
| Voice inquiries | |

The Offers that are distributed through the Sizzle Offer Engine are used to stimulate some basic behaviors and transactional responses from the end users, including saving the offers automatically to an internal app wallet to review later, or to engage live with purchase, game, contest, sweepstakes, access knowledge, opt in, download or other direct response related activities, or to store those interests into a database that offers content using certain activities, including the triggering of video, audio, pictures, or 3D models and animations surrounding those interests to the user on a regular basis.

All data about how the User engages with the system is tracked and stored to assist in making a better user experience.

However, while there exists numerous methods for delivering an offer to a user in traditional media, there has never been an Offer Engine, a cloud-based Pull Advertising system that correlates all of the existing triggers in the Sizzle Network system: a pressure sensitive top layer atop streaming media, or a selective frequency audio listening system, or scanning a visual trigger, receiving a GPS signal, machine learning based stimuli, reacting to beacon, RFID signals, voice inquiries, artificial intelligence stimuli, QR Code recognition, search functionality within the Offer Engine, time-based offers and facial recognition to stimulate some basic behaviors and transactional responses from the end user with offers that may deliver information, transactions, interactivity and entertainment, from all forms of media and locations in all languages, worldwide. And there has never been an Offer Engine that allows all of these offers to distribute Pull Advertising campaigns via a Global Transmedia Network in which all global locations, medias, and engagements are interconnected in one Network of systems.

And while various triggers in the Sizzle network are being currently utilized in other applications, there has never been a comprehensive, single Pull Advertising system that integrates all of the technologies, triggers, media and locations into a comprehensive global transmedia network that facilitates an interconnectivity of all of those variables into a comprehensive web of solutions for engaging the consumer, selling products, delivering information and entertainment and generating interactive playing of games and sharing of social media experiences in a single cloud based system that delivers these options to mobile devices of all kinds.

Thus, one or more embodiments of the present invention are directed to addressing one or more of the problems identified herein.

### SUMMARY OF THE INVENTION

From the foregoing, it is seen that it is a problem in the art to provide a device meeting the above requirements. According to the present invention, a device is provided which meets the aforementioned requirements and needs in the prior art.

The present invention relates to a business and a technology platform which uses triggers for making all forms of media, technologies and locations, instantly transactional, informational and interactive, on mobile devices, iot devices, virtual devices, tablets, and robots using a pull advertising/marketing model; and wherein the triggers include visual recognition, character recognition, machine learning, neural network, artificial intelligence, GPS, beacon, rfid, qr code, search, time, voice recognition, face recognition, expression recognition, object recognition, audio signals, augmented reality, screen pressure sensitivity, and games of all kinds, in all formats.

The sizzle offer engine is a system and method for using triggers to provide instantaneous transactional, informational, interactive and entertainment capabilities to all locations and all forms of prerecorded media, live media, streaming media, print media, physical locations, virtual reality, augmented reality, mixed reality, gaming systems, internet of things, robotics, and social media.

Instantaneous transactional capabilities are also added to signs, billboards, out of home advertising, logos, packaging, business cards, advertising campaigns, direct response campaigns, and to all broadcast media, gaming and all other forms of media.

The sizzle offer engine uses combinations of presentations in all media, combined with a merchant banking global infrastructure, to create transactions of all kinds, by embedding the triggers into all forms of media for commercial, informational, educational, promotional, entertainment and other applications.

The present invention relates to a system and method of a Sizzle Offer Engine, a cloud-based system that correlates all of the existing triggers in the Sizzle system, including: visual recognition, machine learning, artificial intelligence, GPS, beacon, RFID, QR code, search, time, voice recognition, face recognition, audio signals, augmented reality, screen pressure sensitivity, and games of all kinds, and delivering offers via these triggers to Sizzle users on mobile devices in all locations worldwide.

The Transactional Offer Engine and Media Platform of the present invention comprises a unique, interactive, audience-integrated universe. The system and method may comprise of cutting-edge apps that are populated with any combination of streaming video sources such as YouTube, Netflix, Home Shopping Network, NBA, FIFA and other sources such as individual corporations like Macy's, Home Depot, Lowes, JC Penny and others. The Transactional Offer Engine and Media Platform will accompany media in all formats, including the playing of a prerecorded or live streaming video source inside of an app or on any smart device, tablet, computer, laptop, virtual reality, augmented reality, mixed reality or other media system in which the triggers stimulate the opportunity for the end user to receive offers for transaction or interactive engagement of any kind, during the streaming or playing of the media and to collect those offers in a wallet for interaction at a time designated by the user.

The present invention also allows for the listening to the spoken words by the user to gather likes and dislikes for an artificial intelligence-based internal suggestion engine to provide targeted content for that end user on an ongoing basis, as well as delivering games that provide stimuli to purchase, or to react to any other stimuli from the Sizzle Offer Engine for the purpose of generating a sale, engaging a user to interact, provide numerous forms of data, track the user's retina movement, and stimulate the user to participate in numerous potential offer outcomes as delineated in the Sizzle Offer Engine.

When a smart phone, which is enabled with the Sizzle Network technologies, is exposed to any of these triggers, with the app launched, the triggers generate interactivity throughout the Sizzle Network. These same functionalities will be present in a separate API that will allow other apps, games and systems to insert the Sizzle Network into their system and license the software that Sizzle provides.

The Sizzle Network may also comprise a substantial library of augmented reality experiences featuring a blend of engaging personalities, exciting environments, and innovative experiences that create user interaction and generate worldwide app deployments through which new business models may be promoted and explored. In this manner, the Sizzle Network is intended to be extraordinary, ingenious and/or fun. The Sizzle Network incorporates all forms of Augmented Reality content to its greatest use by leveraging it to make all kinds of transactional business models for every vertical of industry, politics, charity, or organization.

Whether new entertainment portal or digital tradeshow for any type of corporation or virtual performance, demonstration or dissemination of information, The Offer Engine and Transactional Media Platform may be configured to support any interactive development, and/or continual audience integration that other apps are incapable of providing as an interactive layer on top of a streaming video source.

In one embodiment, the system of the invention may comprise an invisible layer on top of a video player which is programmable to touch at any physical location on the top of the video player, combined with any particular point in the timeline of the video, user demographic, GPS, and other key variables as to create unique and distinct offers or elements of interactivity. Those interactive elements can be used for commerce, gaming, information dissemination and more. They may be used to sell merchandise and experiences, create games using Easter eggs, generate contests using hand/eye coordinated experiences, launch quizzes and surveys, deliver offers of all kinds, link to games of all kinds, create interactive storytelling with branching paths of videos and create a live shopping experience during streaming media viewing.

In yet another embodiment, the method of the invention may comprise the steps of: (i) encoding a specific video and placing it into a streaming server system; (ii) recognizing the key moments of the video by programming distinct segments on the timeline of the video, paired with physical coordinates within the aspect ratio of the video frame; (iii) associating the target in the video clip with a specific offer via the association device; (iv) accessing the offer from a storage device; and (v) allowing that offer to be engaged by the end user to complete a transaction, game, offer, opportunity or other interactive call to action.

In yet another embodiment of the invention, The Sizzle Offer Engine™ may be built into a mobile device as a stand alone platform or a Software Development Kit for insertion into other apps, to add a selection of Sizzle's Offer Engine features to other apps in either a branded or nonbranded use.

In another embodiment of the present invention, an Augmented Reality Holograms ARH™, a system for providing motion augmented reality interactive displays on mobile devices in which participants may optionally promote products, entertainment, events, information, and other subjects through the use of both augmented reality and virtual reality technologies, may be provided as a result from any one of the twelve triggers in the Sizzle System. The system of the invention may comprise a mobile app framework infused with various combinations of augmented reality functionalities. For example, the system and method of the invention may provide virtual ARH exhibits, recaps of previous events, promotions of coming events, explorations of products, services, and/or other first person virtual ARH experiences. In one embodiment, the communication server of the invention may provide regular updates and information and data flow from app owner to their end users. In addition, the app may be structured to be virtual so that exhibits, content and/or functionality may be changed with each offer programmed inside the Offer Engine.

In another embodiment of the invention, a system for providing virtual contests with variables which may change on a periodic, such as on a daily, or hourly, basis may be provided through the use of the Sizzle Offer Engine's interactive tools, and/or systems. In one embodiment, the virtual set may be programmed with alternating variables that qualify to win prizes of ever increasing value predicated upon the complexity and odds of solving a puzzle on a daily basis. Some puzzles, like guessing a number or pattern sequence, may be individualized by leveraging a User ID, the time of day, and/or other variables on their phone or other mobile device to generate a random number sequence that allows a participant a predetermined number of attempts to solve the puzzle for prizes on a periodic, such as a daily, basis. In another embodiment, games can be delivered through spinning wheels, sequencing squares, and other formats to illustrate games of chance that deliver outcomes of either offers or prizes. In another embodiment, the user can choose from multiple floating augmented reality objects like a Pepsi bottle, with the chance that the specific bottle that the user chooses will correlate to an offer or a prize.

In one embodiment, the system of the invention may comprise a camera capable of capturing still and/or video images, a target/image/video clip association device in optical and digital communication with the camera; a storage device wherein the storage device may store video or other images; and a display which is capable of displaying a combined image of video received from the camera and/or the storage device. The resulting video clip/image associated with the target object may form a combined augmented reality video with alpha channel functionality which ultimately concludes with a financial transaction for the sale of products, services, information, or contribution to charitable or political causes.

In yet another embodiment, the method of the invention may comprise the steps of: (i) capturing a target object image via a camera or other device which has the capability of capturing an image of a target object; (ii) recognizing the target object via a target/image/video clip association device; (iii) associating the target with an image or video clip via the association device; (iv) accessing the image or video clip from a storage device; and (v) playing the video clip/image in association with the target object on a display. The resulting video clip/image associated with the target object may form a combined augmented reality video with alpha channel functionality. This functionality may be triggered from a visual, audio or pressure-sensitive code that has been paired with media and an offer in the Sizzle Network Offer Manager system, a PC-based, globally-hosted server system for allowing all media connectivity with triggers as well as all management of that media plan over the course of time.

In yet another embodiment of the invention, The Augmented Reality Holograms Platform™ may be built into a mobile device as an app platform comprising compelling experiences which may vary with large capacity and an entertaining interactive user interface, such that it will entice repeat usage from users. And generate a viral social media distribution of content generated in the Sizzle Network on behalf of the brands, companies and organizations using the platform.

In another embodiment of the invention, an audio code at approximately 18000 hz −3 db is embedded into a live or prerecorded audio or visual media platform which is then heard by the Sizzle Network app, which then presents a correlated offer to that audio code which is viewable instantly and simultaneously stored in a wallet inside the Sizzle Network apps. This inaudible audio is either prerecorded into existing media, or may be created concurrent to a live event through the Sizzle Network Offer Engine dashboard system.

In another embodiment of the invention, the Sizzle Network apps may be used to watch streaming media, and initiate offers which may be transacted upon by using a pressure-sensitive trigger that initiates the transaction at the user's option while viewing the streaming media. This trigger is encoded into the media using the Sizzle Offer Engine and media encoding systems to place transactional opportunities throughout all of the media, or only in select moments. The Sizzle Offer Engine tracks all of the insertions and coordinates the consumer's transactional request with the proper transaction that is offered during that segment of media.

In another embodiment of the invention, the Sizzle Network creates the opportunity for the licensing of existing corporate brand assets for the transactional opportunity of an appropriately partnered brand sale. As a consumer points the Sizzle app at a sign, ad, business card, product label, display, television commercial, streaming video, games, apps, location, an Augmented Reality Holograms presentation may be triggered and combined with a transactional opportunity. This response from the brand media is paired with a complimentary brand to both company's benefit.

In another embodiment of the invention, a political campaign, or nonprofit organization may use audio broadcasts on the radio, streaming media, or visual triggers to solicit contributions for no value of goods or services exchanged.

In another embodiment of the invention, a brand may offer games using Sizzle Spin technologies to deliver prizes and offers as a result of spinning a wheel, which has predetermined outcomes built into the opportunity through the Sizzle Offer Engine.

In another embodiment of the invention, a brand may deliver games to Sizzle app users by delivering augmented reality floating products, which provide a numerically driven game of chance for the delivery of offers and prizes.

In another embodiment of the invention, the Sizzle Offer Engine™ may deliver special offers that are geofenced to a specific location, territory or facility for the purpose of delivering narrow focused offers to an elite population that is in those locations for the receipt of offers, information, prizes or entertainment.

In another embodiment of the invention, the Sizzle Offer Engine™ may deliver special offers that are correlated to engage with robots of every kind, using the Sizzle Robotic Interface. These offers, opportunities, prizes and contests are delivered to the robotics using numerous Sizzle trigger systems.

In another embodiment of the invention, the Sizzle Offer Engine™ may deliver special offers that are integrated with the Internet of Things and which are unique to the particular product or system which the Sizzle Offer Engine is set to engage with.

In another embodiment of the invention, the Sizzle Offer Engine™ may deliver special offers that are delivered or found using search technologies, whether typed, or communicated through Alexa, Siri or other artificial intelligence.

In another embodiment of the invention, the Sizzle Offer Engine™ may deliver special offers that are created through Machine Learning which studies the users photo library and delivers content, offers and information that is pertinent to the end user, predicated upon their likes and dislikes within their photos.

In another embodiment of the invention, the Sizzle Offer Engine™ may deliver special offers that are delivered to the user through the use of beacon and RFID technologies.

In another embodiment of the invention, the Sizzle Offer Engine™ may deliver special offers that are specially found by scanning of a quick response code.

In another embodiment of the invention, the Sizzle Offer Engine™ may deliver special offers that are time based by leveraging the time on the user's device, and ensuring that time sensitive offers arrive at exactly the correct minute.

In another embodiment of the invention, the Sizzle Offer Engine may deliver special offers that are timed to catch the user at a prime moment, such as the winning moment of a sports championship, or during the broadcast of a live event, concert or experience.

Other objects and advantages of the present invention will be more readily apparent from the following detailed description when read in conjunction with the accompanying drawings.

### BRIEF DESCRIPTION OF THE DRAWINGS

FIG. 1 is a schematic diagram of the offer engine of the present invention in use, receiving offers from companies, and communicating with media companies and other metaverses to distribute offers and transaction codes.

FIG. 2 is a schematic diagram depicting the offer engine interacting with various categories and types media, activities and functions.

FIG. 3 is a schematic flow diagram, which illustrates a flow path for making all media transactional.

FIG. 4 is a schematic diagram which illustrates six major categories of transactional media, used with the present invention.

FIG. 5 is a schematic diagram which depicts a display generated by one embodiment of the system and method of the invention, which illustrates the five major methods of monetizing the offer engine as a transactional media platform of the present invention.

FIG. 6 is a schematic diagram which depicts four major categories of user for the transactional media platform of the present invention.

FIG. 7 is a schematic diagram which illustrates flow of the offer from major categories of participants offering goods and services, to the offer engine of the present invention, and to various categories of results.

FIG. 8 is a schematic diagram which illustrates a technical stack, which collectively embody the features of the offer engine of the present invention, and specifically as it functions as a transactional media platform.

FIG. 9 is a schematic diagram illustrating an offer engine network diagram, depicting technical elements of a network within which the offer engine communicates with users and third parties, and depicts paths to perform transactions.

FIG. 10 is a schematic diagram of a consumer's computer having a metaverse viewer which includes interaction with trigger events for marketing, illustrating connection of the offer engine to the metaverse client viewer.

FIG. 11 is a flowchart illustrating steps for associating triggering events with a camera, and using the offer engine to provide offers to consumers.

FIG. 12 is a schematic block diagram, illustrating types of objects which can have triggers, and events which activate these triggers.

FIG. 13 is a schematic diagram of the offer engine of the present invention, surrounded by blocks showing things it can interact with, respond to, and use.

### DETAILED DESCRIPTION OF THE INVENTION

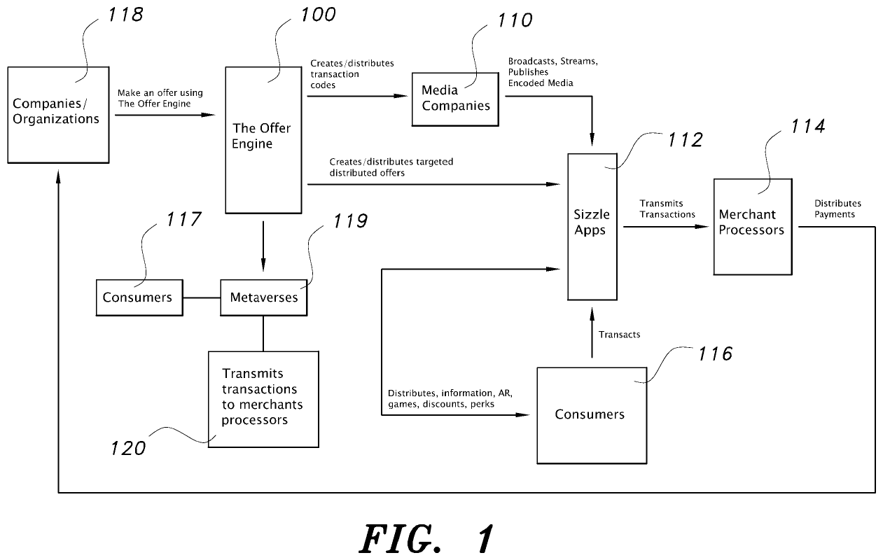

FIG. 1 is a schematic diagram of an offer engine 100 of the present invention in use, receiving offers from companies shown in block 118, and communicating with media companies 110 and other metaverses 119 to distribute offers and transaction codes. The media companies 100, as well as the metaverses 119, carry the offers and transaction codes in encoded media such as broadcasts ans streams, and then to Sizzle apps 112 (such as offer engine-based apps for smart devices). The offer engine 100 can directly create and distribute targeted media to the sizzle apps 112.

The sizzle apps 112 transmits transactions to merchant processors 114, who in turn distribute payments as shown by the solid line from block 114 to a block 118 representing the companies and organizations who provide the initial offers to the offer engine 100. The sizzle apps 112 also communicate with consumers 116 for providing information, AR, games, discounts, and perks, among other possible features. The consumers 166 also can transact purchases, for example, with the sizzle apps 112.

The metaverses 119 similarly communicate with merchant processors as shown at block 120, and also communicate with consumers as shown at block 117.

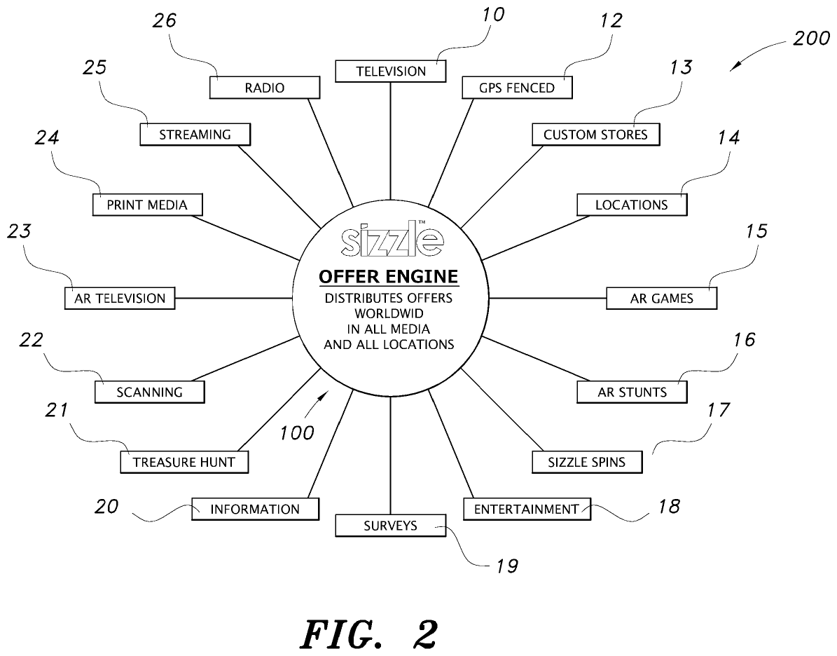

FIG. 2 is a schematic diagram 200 depicting the offer engine 100 interacting with various categories and types media, activities and functions, which include television 10, GPS Fenced 12, custom stores 13, locations 14, AR games 15, AR stunts 16, Sizzle spins 17, entertainment 18, surveys 19, information 20, treasure hunt 21, scanning 22, AR television 23, print media 24, streaming 25, and radio 26.

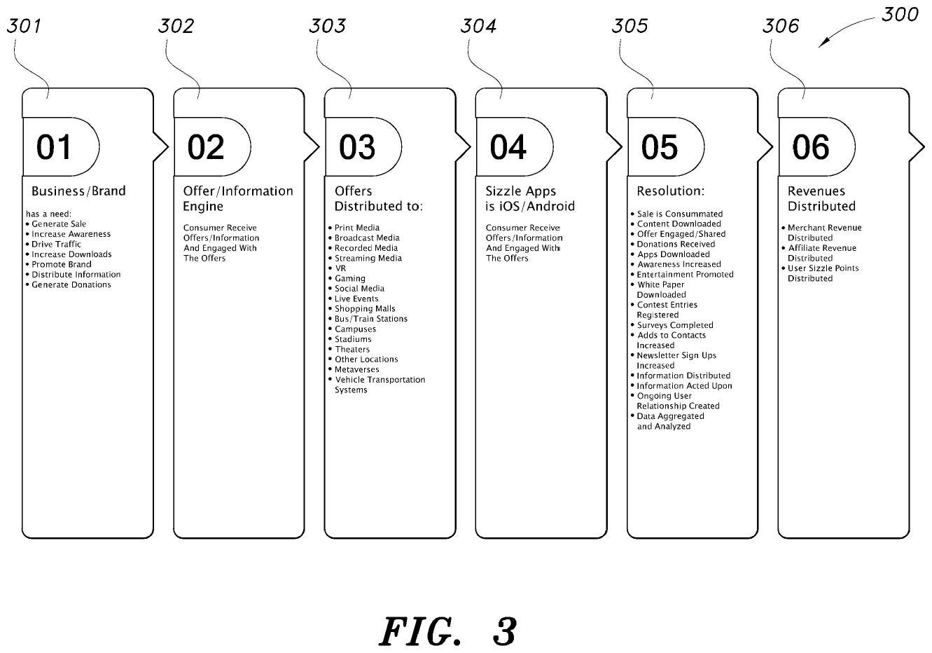

FIG. 3 is a schematic flow diagram, which illustrates a flow path for making all media transactional. At block 301, a business or brand has a need, e.g. to generate sales, drive traffic, and so on, as listed in block 301. Then follows block 302, which is the offer engine 100, through which customers receive offers and information, and becomes engaged with the offers. This is followed by block 303, wherein offers are distributed to print media, broadcast media, and numerous others as listed in block 303.

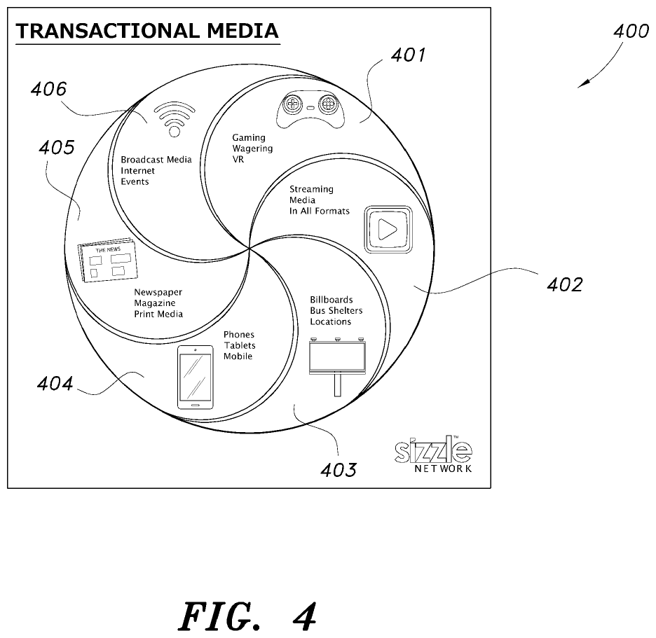

As shown in FIG. 4, block 304 follows block 303, and shows sizzle apps for example in iOS Android, wherein consumers receive offers and information, and are engaged with the offers. This is followed by block 305, which represents resolution of the offers and information, e.g. a sale is consummated, content downloaded, and other items as listed in block 305. This leads to block 306, in which revenues are distributed, for example wherein merchant revenue and affiliate revenues are distributed, and wherein user sizzle points are distributed.

FIG. 4 is a schematic diagram 400 which illustrates six major categories of transactional media, used with the present invention. These categories include gaming and wagering 401, streaming media 402, billboards and signs at bus shelters and other locations 403, phones, tablets and mobile devices 404, newspaper, magazine, and print media 405, and broadcast media and internet events 406.

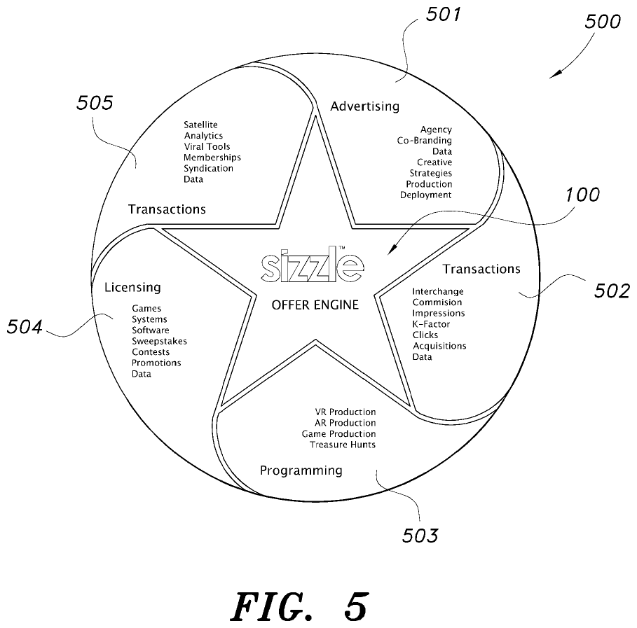

FIG. 5 is a schematic diagram 500 which depicts a display generated by one embodiment of the system and method of the invention, and which display illustrates five major methods of monetizing the offer engine 100 as a transactional media platform. The five major methods include advertising including the types listed in block 501, transactions of the types listed in block 502, programming including the types listed in block 503, licensing including the types listed in block 504, and transactions of the types listed at block 505.

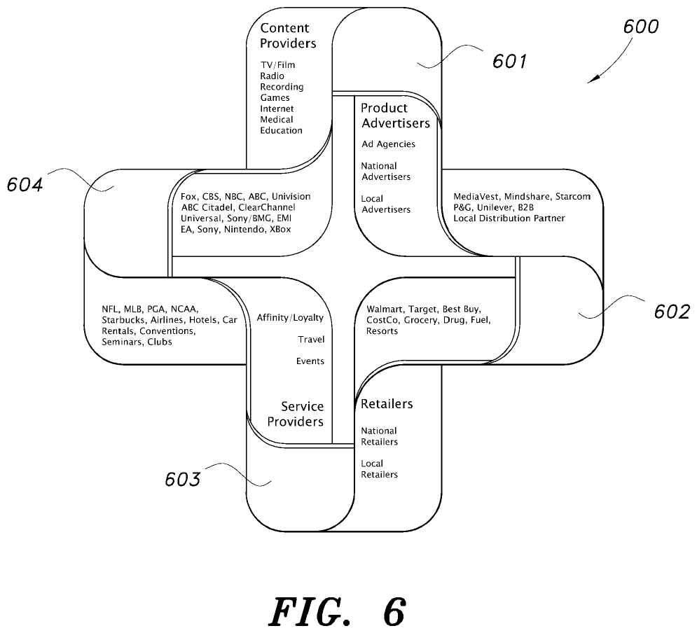

FIG. 6 is a schematic diagram 600 which depicts four major categories of user for the transactional media platform portion of the offer engine 100 of the present invention. The product advertisers are at block 601, listing several types as examples. Specific retailers are listed by way of example at block 602. Specific service providers and specific services (such as travel, events, and so on) are listed in block 603. Specific content providers are listed in block 604, including TV and film producers, radio, and others listed at block 604.

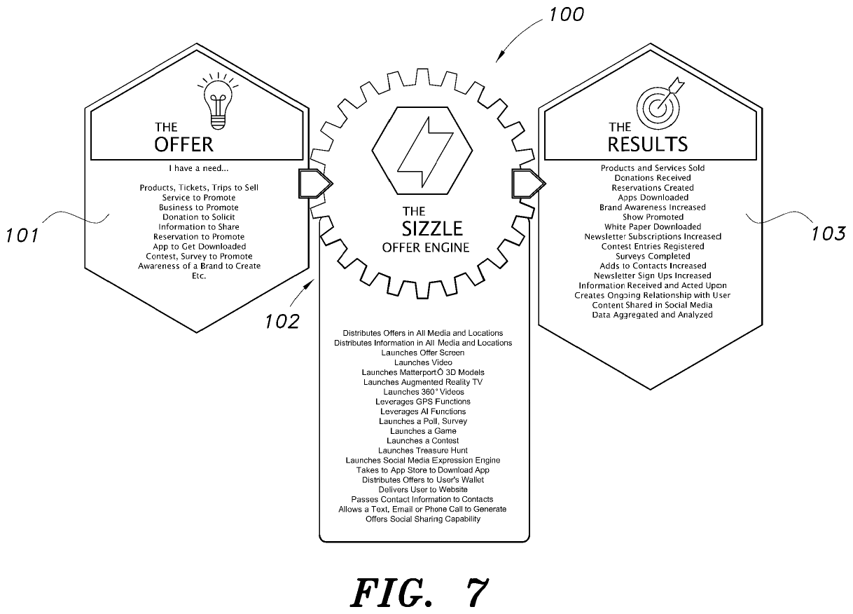

FIG. 7 is a schematic diagram which illustrates flow of the offer 101 from major categories of participants offering goods and services as listed in block 101, to the offer engine 100 of the present invention listing numerous examples of the offer engine 100 functions at block 102, and to block 103 listing various categories of results.

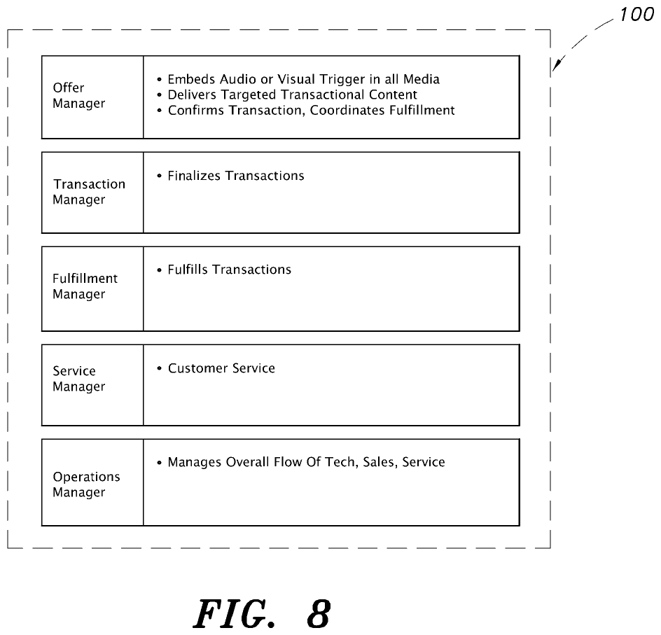

FIG. 8 is a schematic diagram of transaction functions of the offer engine 100, which illustrates a technical stack, which collectively embody the features of the offer engine of the present invention, and specifically as it functions as a transactional media platform. These elements include an offer manager having the functions listed, a transaction manager, a fulfillment manager, a service manager, and an operations manager, all having the features and functions shown in FIG. 8.

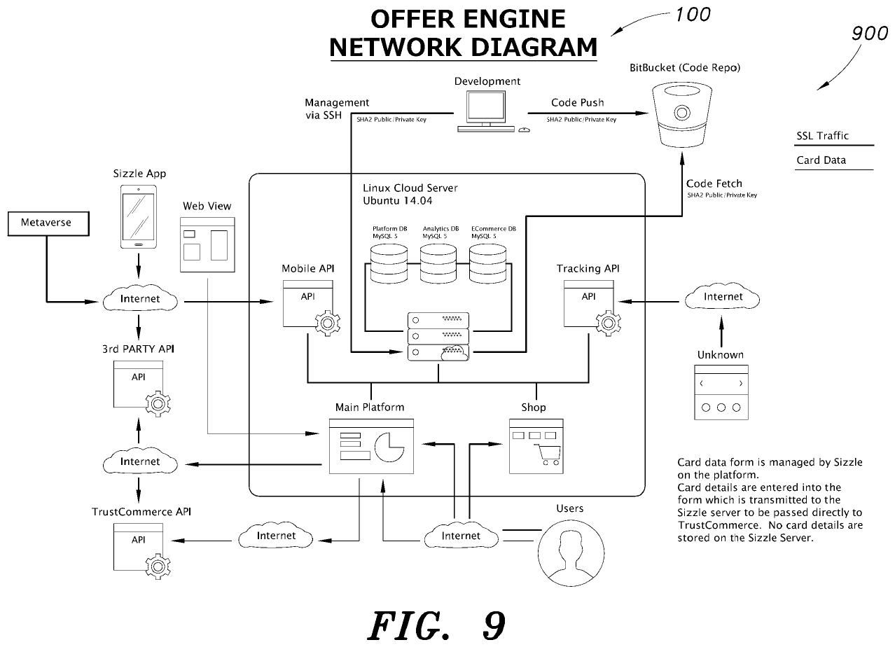

FIG. 9 is a schematic diagram illustrating an offer engine 100 having a network diagram 900 of the offer engine 100, depicting technical elements of a network within which the offer engine 100 communicates with users and third parties, and depicts paths to perform transactions. The elements are as shown in FIG. 9, along with the functions thereof.

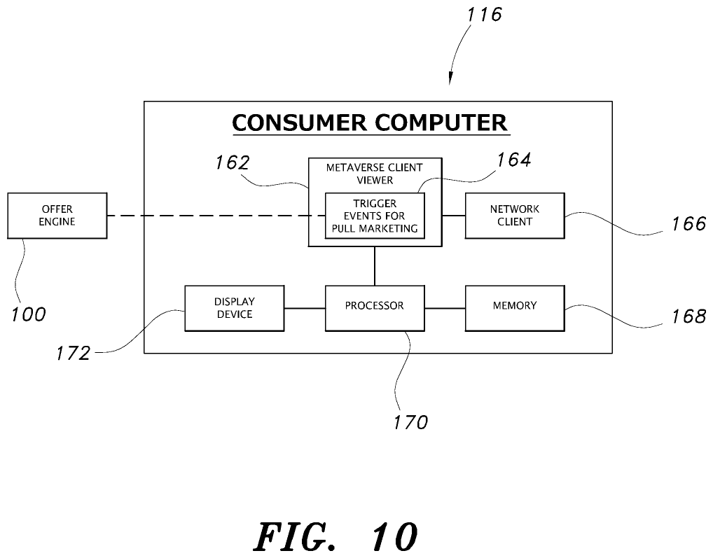

FIG. 10 is a schematic diagram of a consumer's computer 116 having a metaverse client viewer 162 which includes trigger events 164 for pull marketing. Pull marketing is any interaction initiated by a user, such as clicking on an object to gain information about that object, e.g. clicking on a specific car can result for example in a video promotion for that vehicle, among other possible results. The offer engine 100 communicates with the trigger events 164 in any of the previously discussed ways. The computer 116 also includes a network client 166, a processor 170, a display device 172, and a memory 168.

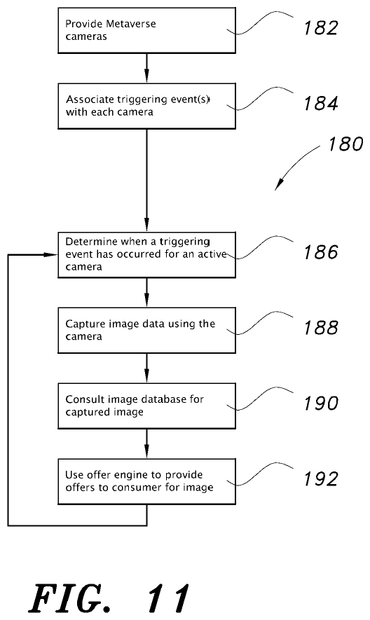

FIG. 11 is a flowchart illustrating steps for associating triggering events with a camera, and using the offer engine 100 to provide offers to consumers. In this flowchart, step 182 is to provide metaverse cameras, step 184 is to associate triggering events with each camera, step 186 is to determine when a triggering event has occurred for an active camera, and step 188 is to capture image data using the camera. Then, at step 190, an image database is consulted for the captured image. Following this, at step 192, is to use the offer engine 100 to provide offers to the consumer related to the captured image.

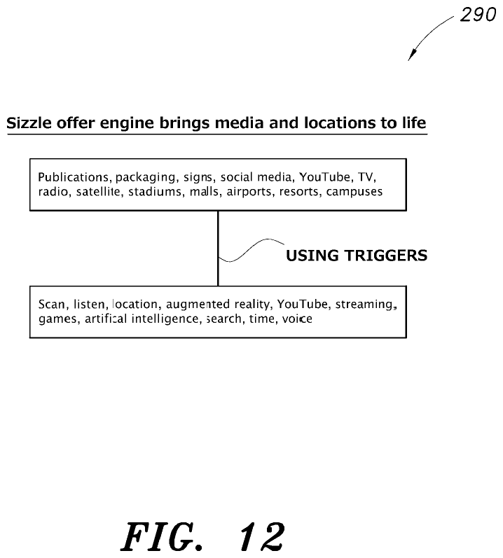

FIG. 12 is a schematic block diagram 290, illustrating types of objects which can have triggers, and events which activate these triggers. The objections can include publications, packaging, signs, and other items listed in the upper box in FIG. 12. The triggers are listed in the lower box, and include listening, location, augmented reality, streaming, games, and other items listed in the lower box. The triggers, when activated, communicate an offer or offers to a consumer who has activate that trigger.

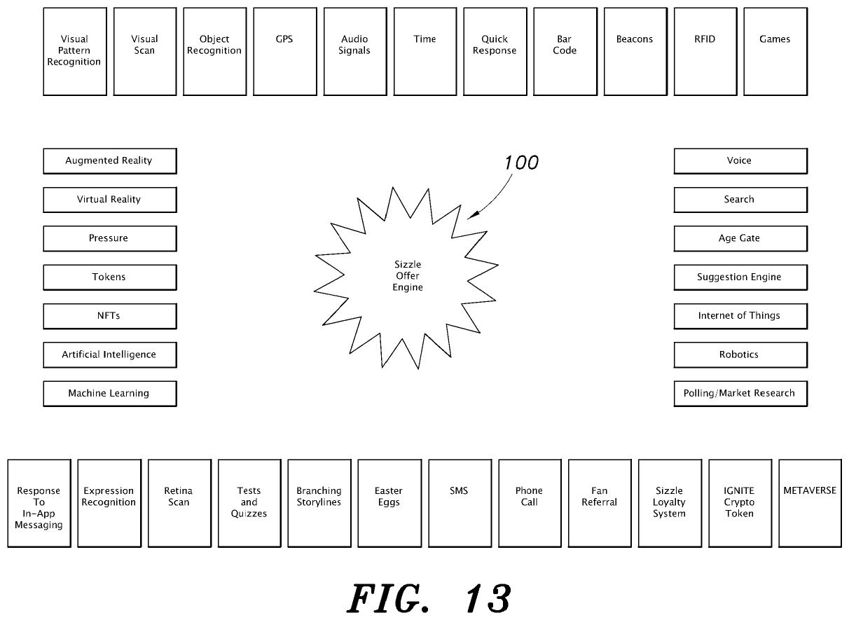

FIG. 13 is a schematic diagram of the offer engine 100 of the present invention, surrounded by blocks showing what it can interact with, respond to, and use. The items are as shown in the blocks surrounding the offer engine 100.

The present invention relates to a business and a technology platform which uses triggers for making all forms of media, technologies and locations, instantly transactional, informational and interactive, on mobile devices, iot devices, virtual devices, tablets, and robots using a pull advertising/marketing model; and wherein the triggers include visual recognition, character recognition, machine learning, neural network, artificial intelligence, GPS, beacon, rfid, qr code, search, time, voice recognition, face recognition, expression recognition, object recognition, audio signals, augmented reality, screen pressure sensitivity, and games of all kinds, in all formats.

The sizzle offer engine is a system and method for using triggers to provide instantaneous transactional, informational, interactive and entertainment capabilities to all locations and all forms of prerecorded media, live media, streaming media, print media, physical locations, virtual reality, augmented reality, mixed reality, gaming systems, internet of things, robotics, and social media.

Instantaneous transactional capabilities are also added to signs, billboards, out of home advertising, logos, packaging, business cards, advertising campaigns, direct response campaigns, and to all broadcast media, gaming and all other forms of media.

The sizzle offer engine uses combinations of presentations in all media, combined with a merchant banking global infrastructure, to create transactions of all kinds, by embedding the triggers into all forms of media for commercial, informational, educational, promotional, entertainment and other applications.

The present invention, The Sizzle Offer Engine, relates generally to the system and process of making all media instantly transactional, informational, interactive and entertaining through the use of triggers.

These triggers are created using:

| | | |
|---|---|---|
| Visual recognition | RFID | Audio signals |
| Character recognition | QRcode | Augmented reality |
| Machine learning | Search | Screen pressure |
| Artificial intelligence | Time | Sensitivity |
| GPS | Voice recognition | Games of all kinds |
| Beacon | Face recognition | |

The triggers are embedded in all forms of existing and to be created media platforms and available in all locations that have access to the internet, worldwide.
These triggers deliver offers, information, interactivity and entertainment by linking the user to many possible outcomes to that offer, including:

| | |
|---|---|
| A specific URL | Virtual reality experiences |
| A specific page in the Sizzle Shop | Augmented Reality Holograms |
| A video | experiences |
| Printed content in a PDF, GIF or | Viral content for creating and sharing |
| HTML5 format | on social media |
| Interactive content | Contact information to add to an |
| Games of all kinds | address book |
| Quizzes | Regionalized offer to where the |
| Tests | consumer is currently standing |
| Polls | An augmented reality treasure hunt |
| Surveys | A directed text message |
| Donation requests | A directed phone call |
| Contests of all kinds | An appointment set on the calendar |
| Sweepstakes | Download an app |
| Virtual tours | Download a white paper |
| 360° videos | Interact with Artificial Intelligence |
| Augmented reality experiences | |
| Interaction with any | |
| IOT technologies | |
| Interaction with any robot | |
| technologies | |

The offers are paired with responses to those offers, on a smart phone, smart television, smart tablet, VR headset or mobile device.

### Additional Application Functionalities

### Bump Portfolio and Digital Business Card

Portfolios may be loaded with three files which may be bumped to a receiving phone. So in the event a conference was created where everyone has the app, one person could collect files from participants that he wishes to review materials from in the same way a business card is exchanged.

### Additional Augmented Reality Functionalities

Additional features may also include potential insertion of sign conversions for language translations, technology overlays and product overlays for description, museum tagging for exhibit information, information expansion systems for opening signs into scrollable information systems with menus, insertion of 3D objects or characters into a room to accentuate the entertainment, or informational experience of the end user.

### Social Network Functionalities

Share with friend or business associate via social network publishing from the Sizzle app, E-mail content of all kinds from the ARH app. Store content may be provided on a mobile or smart device for use in other locations. Send offers from a User's wallet to another User for redemption.

### Monetization of the Invention

For those who choose to set additional revenue creation and growth as a priority within their overall The Transactional Media Platform™ deployments. These include:

### A. The Store

A Virtual Shop selling digital and tangible assets of any desirable kind. Products, experiences, services, entertainment, information, games, apps, discounts for brick and mortar businesses and more.

### B. Transactional Media

The Transactional Media Platform™ comes equipped with the ability to lay an invisible layer on top of any streaming live or prerecorded media, game, virtual reality, augmented reality, mixed reality media and make it instantly transactional.

### Reporting and Analytics

The Transactional Media Platform will also be configured to quickly investigate ad and user metrics within both graphical and statistical formats. The Transactional Media

Platform supports an extensive variety of built in analytics capabilities, ranging from quick dashboard summaries to detailed traffic and transaction data. The reports may be integrated directly into a dashboard, which may provide a broad overview of the distribution metric performance. Operations control and media distribution may be provided via distributed and local server clusters.

The reporting and analytics functionality may include:

### i. Activity Reports

Identify a user's browsing and purchasing pattern, viewing patterns and monitor the performance of specific titles, sets, props, interactive features, games, etc. Know exactly who did what, where and when.

### ii. Traffic Reports

Identify the primary sources of traffic to each part of The Transactional Media Platform

### iii. Title Completion

See how often a specific title is typically viewed to completion.

### iv. Affiliate Performance

Track the incremental traffic specific affiliates are driving to a user's app and the user's app's content. Understand how individual titles are performing across all of your affiliates.

### vi. Custom Analytics

Customize information captured to the specific client requirements.

### N. Downloadable Video On Demand (“VOD”)

In some embodiments of the invention, the Transactional Media Platform may be equipped with a downloadable movie function. Or a pay wall to pay for the viewing of restricted pay per view content.

Other features and aspects of the present invention may also include one or more of the following:

A system and/or method for providing virtual environments on a mobile device which integrate with gyro technologies on the device for integrated Augmented Reality Holograms comprising:

A remote device usable by a first participant which downloads the app from the app store, launches the app and initiates the creation of a virtual environment.

A system and/or method, wherein the virtual world integrates precisely with a real world for combinations of virtual and augmented reality interactions between the two for the benefit and entertainment of the end user.

A system wherein the virtual world integrates an ever changing game for each end recipient by providing a series of tiles/buttons/stimuli of any nature to determine if they have won a prize. Based on the number of correct choices that they made, end user wins increasing level of prizes. Answers to puzzles are changed daily for each individual end user based upon his unique user ID and other mathematical variables like serial number, date, time, cell phone number to ensure that the daily answers are changed for each user, each day.

A system and/or method wherein the virtual world integrates a digital membership card that enables them to be scanned at brick and mortar locations for discounts provided on the virtual world platform.

A system and/or method wherein the virtual world integrates a code redemption system and/or method wherein the codes issued in the brick and mortar world are redeemed in the virtual world for digital products, swag or access to new territories or media materials.

A system and/or method wherein the virtual world integrates an individual digital stage for the end user to customize to their liking and send end users to catch their bump shared swag materials through their customized stage portal.

A system and/or method wherein the virtual world integrates a bump portfolio and digital business card. Bump technology allows end users to bump digital files from their phone to any willing recipient so that a trade of swag material is easily accomplished.

A system and/or method wherein the app integrates all augmented reality functionalities such as the insertion of sign conversions for language translations, technology overlays and product overlays for description and training, museum tagging for exhibit information, information expansion systems for opening signs into scrollable information systems with menus, insertion of 3D objects or characters into a room to accentuate the entertainment, or informational experience of the end user.

A system and/or method wherein the app integrates swag trading. Share with friend or business associate via social network publishing from app, Email content of all kinds from app. Store content on your mobile device for use in other locations. Trade swag remotely through intraconnected system.

A system and/or method wherein the app integrates a Virtual Shop selling digital assets of any kind. Entertainment, Information, Games, Apps, discounts for brick and mortar businesses and more. Also micropurchases for decoration of the end user's space/office decor.

A system and/or method wherein the app integrates virtual currency within the app. Customers may purchase the virtual currency through the app store for in app purchases.

A system and/or method wherein the app integrates the powerful opportunity to intelligently weave sponsors into this program through great Perks, Prizes, Contests, Promotions, Sponsorship, and Product Placement.

A system and/or method wherein the app integrates support for advertising insertions of commercials, prerolls, sign graphics, 3D object interactivity, game sponsorships, that range from standard to cutting-edge, to drive maximum value.

A system and/or method wherein the app integrates synced ad unit, and optionally a coordinated preroll commercials which connect to 3D object interactivity, games, poster/sign graphics or incoming messages.

A system and/or method wherein the app integrates Ad targeting, featuring a wide range of targeting options

A system and/or method wherein the app integrates Player targeting. Target ads to specific players that may represent sections of websites, affiliate networks, or Social Networking channels.

A system and/or method wherein the app integrates Line Up Targeting. Target ads to specific lineups that may run in one or multiple players in the network.

A system and/or method wherein the app integrates Title Targeting. Target ads to specific video titles in the media distribution network.

A system and/or method wherein the app integrates geo targeted advertising. Targeting ads to specific geographic locations,

A system and/or method wherein the app integrates frequency capping. Control the number of times viewers in your network see an ad.

A system and/or method wherein the app integrates Key Value Identifiers. Target ads to specific criteria that are associated with insertion points within The Augmented Reality Holograms Platform™

A system and/or method wherein the app integrates reporting and analytics. Quickly investigate ad and user metrics within both graphical and statistical formats. The Transactional Media Platform supports a variety of built in analytics capabilities, ranging from quick dashboard summaries to detailed traffic and transaction data. The reports are integrated directly into a dashboard, gives a broad over view of the distribution metric performance. Operations control and media distribution are handled via distributed and local server clusters, including Activity Reports. Identify a user's viewing patterns and monitor the performance of specific titles, sets, props, interactive features, games, etc. Know exactly who did what, where and when.

Traffic Reports—Identify the primary sources of traffic to each part of The global transmedia network that is created within the Sizzle Offer Engine.

Title Completion—See how often a specific title is typically viewed to completion.

Affiliate Performance—Track the incremental traffic specific affiliates are driving to your app and your app's content.

Syndicated Content Performance—Understand how individual titles are performing across all of your affiliates.

Custom Analytics—The system and/or method may comprise customized information captured to the specific client requirements.

Downloadable VOD.—The Transactional Media Platform may be equipped with a downloadable movie function.

Augmented reality further enhances the virtual experience through the addition of visuals and information that bring new dimensions to the real world through programmed functionalities, features and interactive functions In graphics, animation, film, text and artistic interpretations. It will be apparent to one skilled in the art, that the invention may be practiced without at least some of the specific details provided herein. In other instances, well-known features have not been described in detail so as not to obscure the invention. It should also be understood that any method steps discussed herein may further include or involve the transmission, receipt and processing of data through conventional hardware and/or software technology to effectuate the steps as described herein.

The systems and methods disclosed herein may be implemented in digital electronic circuitry, in computer hardware, firmware, software, or in combinations of them. Apparatus of certain embodiments of the invention may be implemented in a computer program product tangibly embodied in a machine-readable storage device for execution by a programmable processor. Method steps according to certain embodiments of the invention may be performed by a programmable processor executing a program of instructions to perform functions of such embodiment by operating based on input data, and by generating output data.

Certain embodiments of the invention may be implemented in one or several computer programs that are executable in a programmable system, which may comprise at least one programmable processor coupled to, receive data from, and/or transmit data to, a storage system, at least one input device, and/or at least one output device. In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Laravel, Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein. In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof. Suitable mobile application development environments are available from several sources. In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications. In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands. In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof. In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the methods, systems, and media disclosed herein include one or more databases, or use of the same. In view of the disclosure provided herein, those of skill in the art will recognize that many databases are suitable for storage and retrieval user profile and geolocation information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices. The functionality and principles of the embodiments disclosed herein are typically implemented by or with software programs, instructions and applications, operating in connection with computer hardware, such as data input/output devices, data processing devices and data storage devices, which may be within the same housing or independent and connected remotely. It is expected that one of ordinary skill, notwithstanding the many design choices motivated by, for example, available time, current technology, and economic considerations, when guided by the concepts and principles disclosed herein will be readily capable of generating such software and selecting appropriate hardware with minimal experimentation. Therefore, in the interest of brevity and minimization of any risk of obscuring the principles and concepts according to this embodiment of the invention, further discussion of such software and hardware, if any, will be limited to the essentials with respect to the principles and concepts used by the preferred or exemplary embodiments. Some embodiments of the invention are directed to systems and methods as described above which are wholly or partially provided through a website and/or downloadable applications and may be supported, enabled or facilitated through components that may include various computer and network related software and hardware, that is, programs, operating systems, memory storage devices, data input/output devices, data processors, servers with links to data communication systems, wireless or otherwise, such as those which take the form of a local or wide area network, and a plurality of data transceiving terminals capable of interfacing with the network, such as personal computers, handheld devices, PDAs, cell phones or any other devices capable of displaying a user interface.

Those skilled in the art will appreciate that the particular types of communication network and devices, software and hardware are not vital to the full implementation of the embodiments described herein or other embodiments within the scope and spirit of the invention. It should be understood that the type of communication network and devices, software and hardware may also vary based on the rapid advances in technology that are ongoing in the industry. In other words, the precise software and hardware configuration of the various embodiments of the invention may vary accordingly while still remaining within the scope and spirit of the invention. Although this description discloses exemplary embodiments including, among other components, software executed on hardware, it should be noted that the embodiments are merely illustrative and should not be considered as limiting. For example, it is contemplated that any or all of the hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

The system and methods of the invention may be used to provide a website through the Internet or otherwise accessible through a global communication network that will allow users to submit and view data.

It should be understood that the order of execution or performance of the steps in the embodiments of the invention described herein is not essential, unless otherwise specified. That is, the steps described herein may be performed in any order, unless otherwise specified, and embodiments of the invention may include additional or fewer operations than those disclosed herein. For example, it is contemplated that executing or performing a particular step before, contemporaneously with, or after another step is within the scope of aspects of the invention. Additionally, features and steps of the embodiments of the invention may be combined and alternated as independent elements of the invention.

In certain embodiments computer programs may be implemented in a high-level and/or object-oriented programming language, and/or in assembly and/or machine code. The language and/or code may be a compiled and/or interpreted language and/or code.

The processors utilized in certain embodiments may include general and/or special purpose microprocessors. Such processors may receive instructions, data, and/or other information from memory devices, storage devices, and/or other internal or external sources.

Memory devices, storage devices, and/or other internal or external sources may be suitable for tangibly embodying computer program instructions and data include forms of non-volatile memory, including by way of example, the cloud, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the eventual claims rather than the foregoing description and the exemplary embodiments described therein.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the inventions described herein and the equivalents thereof.

The invention being thus described, it will be evident that the same may be varied in many ways by any one having skill in the applicable arts. Such variations are not to be regarded as a departure from the spirit and scope of the invention and all such modifications are intended to be included within the scope of the claims.

What is claimed is:

1. A business and a technology platform for transmitting offers to a consumer, comprising:
an offer engine adapted to communicate an offer;
at least one trigger associated with an object which can be activated by the consumer;
said offer being communicated by activation of said at least one trigger.

2. A business and a technology platform as claimed in claim 1, wherein said at least one trigger includes any of an offer being communicated said at least one trigger includes any of visual recognition, character recognition, machine learning, neural network, artificial intelligence, GPS, beacon, rfid, qr code, search, time, voice recognition, face recognition, expression recognition, object recognition, audio signals, augmented reality, and screen pressure sensitivity.

3. A business and a technology platform as claimed in claim 1, wherein said offer engine is adapted to receive offers from third parties, which are then transmitted by said offer engine.

4. A business and a technology platform as claimed in claim 1, wherein as a result of activation of said trigger, instantaneous transactional capabilities are added to any of signs, billboards, out of home advertising, logos, packaging, business cards, advertising campaigns, direct response campaigns, and to all broadcast media, and gaming.

5. A business and a technology platform as claimed in claim 1, wherein said offer engine interacts with categories of transactional media including: gaming and wagering; streaming media; billboards and signs, phones, tablets and mobile devices; newspaper, magazine, and print media; and broadcast media and internet events.

6. A business and a technology platform as claimed in claim 1, wherein said offer engine is adapted to be implemented on mobile devices, iot devices, virtual devices, tablets, and robots using a pull advertising/marketing model

7. A business and a technology platform as claimed in claim 1, wherein said offer engine further comprises a transactional media platform which can investigate ad and user metrics within both graphical and statistical formats, and wherein said transactional media platform supports built in analytics capabilities, including dashboard summaries, traffic data, and transaction data.

8. A business and a technology platform for transmitting offers to a consumer, comprising:
an offer engine adapted to receive an offer from a provider, and is adapted to add a transaction code to said offer and to then communicate said offer to media companies and metaverses;
at least one trigger associated with an object which can be perceived by the consumer and which can be activated by the consumer;
said offer being communicated by activation of said at least one trigger; and
at least one merchant processor for processing transactions by the consumer as a result of receiving said offer.

9. A business and a technology platform as claimed in claim 8, wherein said at least one trigger includes any of an offer being communicated said at least one trigger includes any of visual recognition, character recognition, machine learning, neural network, artificial intelligence, GPS, beacon, rfid, qr code, search, time, voice recognition, face recognition, expression recognition, object recognition, audio signals, augmented reality, and screen pressure sensitivity.

10. A business and a technology platform as claimed in claim 8, wherein said offer engine is adapted to receive offers from third parties, which are then transmitted by said offer engine.

11. A business and a technology platform as claimed in claim 8, wherein as a result of activation of said trigger, instantaneous transactional capabilities are added to any of signs, billboards, out of home advertising, logos, packaging, business cards, advertising campaigns, direct response campaigns, and to all broadcast media, and gaming.

12. A business and a technology platform as claimed in claim 8, wherein said offer engine interacts with categories of transactional media including: gaming and wagering; streaming media; billboards and signs, phones, tablets and mobile devices; newspaper, magazine, and print media; and broadcast media and internet events.

13. A business and a technology platform as claimed in claim 8, wherein said offer engine is adapted to be implemented on mobile devices, iot devices, virtual devices, tablets, and robots using a pull advertising/marketing model

14. A business and a technology platform as claimed in claim 8, wherein said offer engine further comprises a transactional media platform which can investigate ad and user metrics within both graphical and statistical formats, and wherein said transactional media platform supports built in analytics capabilities, including dashboard summaries, traffic data, and transaction data.
